(19) United States
(12) Patent Application Publication
(10) Pub. No.: US 2018/0157115 A1
(43) Pub. Date: Jun. 7, 2018

(54) EDGE-LIT BACKLIGHT DEVICE AND LIQUID CRYSTAL DISPLAY DEVICE

(71) Applicant: SHARP KABUSHIKI KAISHA, Sakai City, Osaka (JP)

(72) Inventor: MITSURU HINENO, Sakai City (JP)

(21) Appl. No.: 15/577,690

(22) PCT Filed: May 25, 2016
(86) PCT No.: PCT/JP2016/065371

§ 371 Date: Nov. 28, 2017

(30) Foreign Application Priority Data
Jun. 1, 2015 (JP) 2015-111600

(51) Int. Cl. G02F 1/1335; F21V 8/00

(52) U.S. Cl. CPC G02F 1/133602; G02B 6/0025; G09G 2320/0233; G02B 6/0055; G02F 1/133528

(57) ABSTRACT

The present invention provides an edge-lit backlight device (100A) utilizing a simple configuration to reduce luminance unevenness, and a liquid crystal display device including the edge-lit backlight device. The edge-lit backlight device includes: a light guide plate (30) configured to emit light incident from an edge surface (31) thereof toward the front; a light source (40) disposed to face the edge surface of the light guide plate with a space in between; and a first optical sheet (70) disposed in front of the light guide plate, the first optical sheet including a structural member (71) extending, in a plan view, in a direction in which light is emitted by the light source toward the light guide plate, the first optical sheet being situated such that an edge thereof adjacent to the light source is farther from the light source than the edge surface of the light guide plate is in a plan view.

### TECHNICAL FIELD

The present invention relates to edge-lit backlight devices and liquid crystal display devices. The present invention more specifically relates to an edge-lit backlight device suitable for use in small and medium-sized liquid crystal display devices, and a liquid crystal display device including the edge-lit backlight device.

### BACKGROUND ART

Backlight devices are lighting equipment for use in display devices such as liquid crystal display devices. For example, a backlight device is disposed behind a liquid crystal panel, and light generated by the backlight device is transmitted through the liquid crystal panel and emitted from the liquid crystal display device toward the viewer. There are roughly two types of backlight devices based on the structure: edge-lit backlight devices and direct-lit backlight devices.

Examples of the structure of edge-lit backlight devices include one in which a light guide plate is provided underneath an optical sheet group including a diffusion sheet and a prism sheet, and light sources are linearly disposed at one end surface of the light guide plate. Light emitted by the light sources is incident on the light guide plate and emitted in an illumination direction (toward the viewer) by the light guide plate.

Examples of the structure of direct-lit backlight devices include one in which a diffuser is provided underneath an optical sheet group including a diffusion sheet and a prism sheet, and light sources are disposed immediately below the diffuser. Light emitted by the light sources is emitted parallel to the main plane of the diffuser toward the viewer.

Since backlight devices are configured to emit light to a liquid crystal panel, backlight devices preferably utilize surface light emission from their entire light emission surface facing the liquid crystal panel. When a backlight device utilizes point light sources such as light emitting diodes (LEDs) or line light sources such as cold cathode fluorescent lamps (CCFLs), in order to reduce point-like or linear luminance unevenness and to achieve surface light emission, edge-lit backlight devices employ the light guide plate and the optical sheet group, whereas direct-lit backlight devices employ members such as the diffuser and the optical sheets. For example, in Patent Literature 1, hot spots and bright/dark lines in the vicinities of the incident surface are controlled and the viewing angle characteristics are controlled using the structural features of the light guide plate.

### CITATION LIST

### Patent Literature

Patent Literature 1: JP 2014-7054 A

### SUMMARY OF INVENTION

### Technical Problem

Lately, small and medium-sized displays for use in devices such as televisions, laptops, tablet devices, and smartphones have been made thinner and provided with narrower frames. An attempt to narrow a frame of an edge-lit backlight device is associated with difficulty in sufficiently diffusing light emitted by light sources, unfortunately resulting in high luminance at or near the light sources. Such an attempt is also associated with streaky or other luminance unevenness which appears from a light incident part toward the center in observation of the front of the backlight device from an oblique direction.

A light guide plate 1 in Patent Literature 1 includes an outgoing surface 11 which is formed by a propagation region 11a, a diffusion-and-propagation auxiliary region lib, and a diffusion-and-propagation region 11c. Hot spots and bright/dark lines in vicinities of the incident surface are controlled primarily by curved portions of prism upper ends formed in the diffusion-and-propagation region 11c. This configuration, however, requires a light guide plate having a complex shape and an extra thickness for the structural member formed on the outgoing surface, increasing the thickness of the backlight device to make it difficult to achieve a thin profile.

The present invention has been made in view of the above current state of the art, and aims to provide an edge-lit backlight device utilizing a simple configuration to reduce luminance unevenness, and a liquid crystal display device including the edge-lit backlight device.

### Solution to Problem

At the beginning of studies on generation of luminance unevenness, the present inventor has first focused on the size and arrangement of optical sheets used in conventional edge-lit backlight devices. In a typical conventional edge-lit backlight device, optical sheets such as a reflective sheet, lens sheet, and polarizing sheet are designed to have the same planar shape and the same size, for reduction of the production cost and ease of assembly. Meanwhile, being likely to warp, sheets are preferably within the light-emitting surface of a light guide plate and are often designed to be situated such that at least two sides of each of the optical sheets are aligned with each other (including the case where one corner and one side are aligned with each other) in order to prevent the optical sheets from rotating and moving. In addition, in the case where it is difficult to take a sufficient distance from a light source to the light-incident surface of the light guide plate because of a narrow frame or any other factor, each optical sheet needs to be brought closer to the light source to a position where the edge of the optical sheet is aligned with the light-incident surface of the light guide plate (the edge surface of the light guide plate).

The inventor has also focused on direct incidence of part of light emitted by the light source on the edge of the optical sheet, which occurs in the state where the edge of the optical sheet is brought closer to the light source. In particular, with an optical sheet having on its surface a structural member extending in a direction in which light is emitted by the light source toward the light guide plate, the light incident on the optical sheet has been found to appear as streaky or other luminance unevenness. Generation of luminance unevenness is now described based on an example of a lens sheet with linear recesses. FIG. 11 is a schematic view illustrating generation of luminance unevenness on a lens sheet with linear recesses. In the case where the extending direction of the recesses of the lens sheet is the same as the direction in which light is emitted as shown in FIG. 11, light incident on the lens sheet is reflected along the structural member such as the recesses to give a high luminance to the regions surrounded by dashed lines, causing streaky or other luminance unevenness.

In order to reduce such generation of luminance unevenness, the inventor has made various studies. The studies made by the inventor revealed that a light guide plate having a complex shape as in Patent Literature 1, with an extra thickness for the structural member, is not suitable for use in making a device thinner. In the case of disposing a diffusion sheet between the light guide plate and an optical sheet such as a lens sheet, light is transmitted through the diffusion sheet and incident also on the edge surface of the lens sheet. The incidence of light can be prevented by light-shielding printing or the like technique, but this increases the number of production steps. In terms of the cost, a light guide plate having a complex shape as in Patent Literature 1 is typically formed by injection molding, for example, and is therefore expensive. Light-shielding printing or the like technique for the lens sheet further increases the cost.

The inventor has further studied how to reduce defects such as generation of luminance unevenness using a simple structure without changing the structures of members such as a light guide plate and a diffusion sheet. The inventor has then found that generation of streaky or other luminance unevenness can be reduced by situating an optical sheet such as a lens sheet with a structural member (e.g., linear recesses) such that an edge of the optical sheet is at a position inside the backlight device and is remote enough from the light source to avoid direct incidence of light from the backlight. In particular, generation of streaky or other luminance unevenness can be reduced by situating an optical sheet having on its surface a structural member extending in a direction in which, in a plan view, light is emitted by the light source toward the light guide plate, such that an edge of the optical sheet adjacent to the light source is farther from the light source than the edge surface of the light guide plate is in a plan view. Thereby, the inventor has arrived at a solution to the above problem, accomplishing the present invention.

One aspect of the present invention may be an edge-lit backlight device including: a light guide plate configured to emit light incident from an edge surface thereof toward the front; a light source disposed to face the edge surface of the light guide plate with a space in between; and a first optical sheet disposed in front of the light guide plate, the first optical sheet including a structural member extending, in a plan view, in a direction in which light is emitted by the light source toward the light guide plate, the first optical sheet being situated such that an edge thereof adjacent to the light source is farther from the light source than the edge surface of the light guide plate is in a plan view.

With the above edge-lit backlight device, a liquid crystal display device can be obtained which reduces generation of luminance unevenness. In other words, another aspect of the present invention may be a liquid crystal display device including: a liquid crystal panel; and the edge-lit backlight device, the edge-lit backlight device being disposed behind the liquid crystal panel.

### Advantageous Effects of Invention

The edge-lit backlight device of the present invention avoids direct incidence of light emitted by the light source on an optical sheet having on its surface a structural member extending in a direction in which light is emitted by the light source toward the light guide plate. Thereby, the edge-lit backlight device can reduce generation of streaky or other luminance unevenness. The liquid crystal display device of the present invention, including the edge-lit backlight device, can therefore reduce generation of luminance unevenness.

### BRIEF DESCRIPTION OF DRAWINGS

FIG. 1 is a schematic cross-sectional view of an exemplary edge-lit backlight device of Embodiment 1.

FIG. 2 is a plan perspective view schematically showing an exemplary edge-lit backlight device of Embodiment 1.

FIG. 3 is a photograph showing a light diffusion state in Embodiment 1.

FIG. 4 is a schematic cross-sectional view of an exemplary liquid crystal display device including the edge-lit backlight device of Embodiment 1.

FIG. 5 is a schematic cross-sectional view of an exemplary edge-lit backlight device of Embodiment 2.

FIG. 6 shows photographs showing light diffusion states, with the position of an edge Of a reflective sheet changed.

FIG. 7 shows photographs showing light diffusion states, with the position of an edge of a reflective sheet unchanged.

FIG. 8 shows photographs comparing reflection states with an edge of a reflective sheet situated at different positions.

FIG. 9 is a schematic cross-sectional view showing an exemplary edge-lit backlight device of Embodiment 3.

FIG. 10 is a photograph showing a light diffusion state in Comparative Embodiment 1.

FIG. 11 is a schematic view illustrating generation of luminance unevenness on a lens sheet with linear recesses.

### DESCRIPTION OF EMBODIMENTS

Hereinafter, embodiments of the present invention are described with reference to the drawings. The embodiments, however, are not intended to limit the scope of the present invention. The configurations of the embodiments may appropriately be combined or modified within the spirit of the present invention.

### Embodiment 1

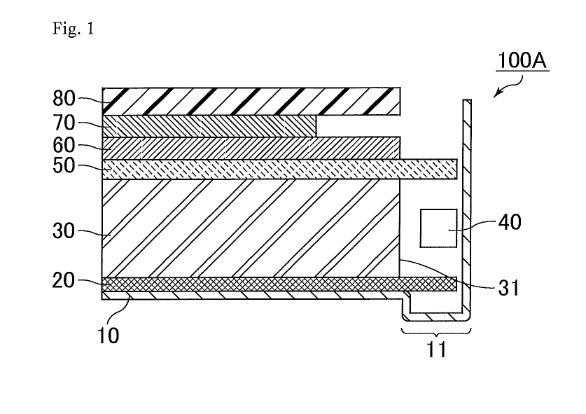

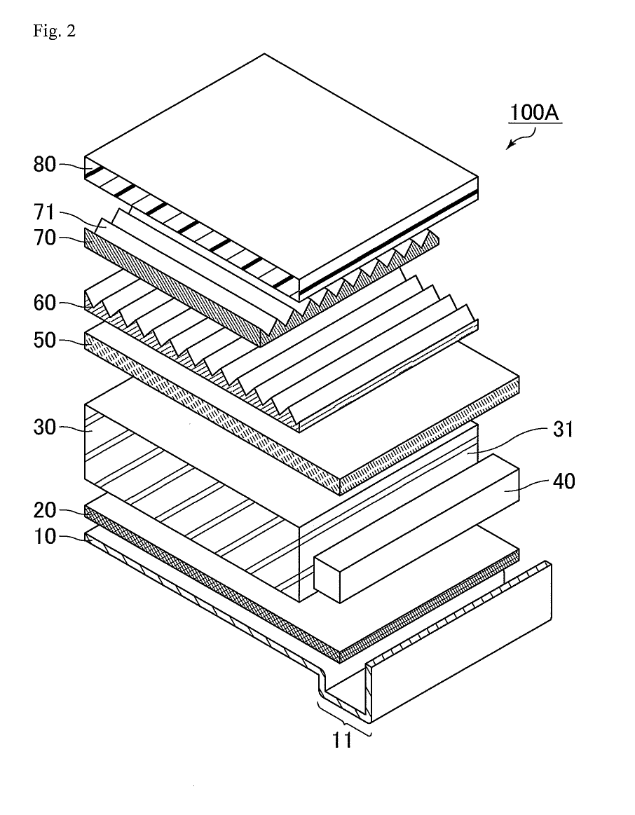

FIG. 1 and FIG. 2 are schematic views of an exemplary edge-lit backlight device 100A of Embodiment 1. FIG. 1 is a schematic cross-sectional view and FIG. 2 is a planar perspective view. In FIG. 1, the top of the drawing corresponds to the front of the backlight device and the bottom of the drawing corresponds to the back of the backlight device. As shown in FIG. 1, the backlight device of Embodiment 1 includes, in the given order from back to front, a frame 10, a reflective sheet 20, a light guide plate 30, a diffusion sheet 50, a second optical sheet 60, a first optical sheet 70, and a polarizing sheet 80. A light source 40 is disposed to face an edge surface 31 of the light guide plate 30 with a space in between.

The first optical sheet 70 may be a lens sheet. A lens sheet is also called a prism sheet, and has a function (light-concentrating function) of intensively increasing, toward a light-emitting surface of the backlight device, the luminance of light that is emitted by the light source 40 toward the edge surface 31 of the light guide plate 30 and then emitted by the light guide plate 30 toward the front of the backlight device. Examples of the material of the lens sheet include resins such as acrylic resin, styrene, polycarbonate, polyethylene terephthalate, acrylonitrile, epoxy acrylate, and urethane acrylate.

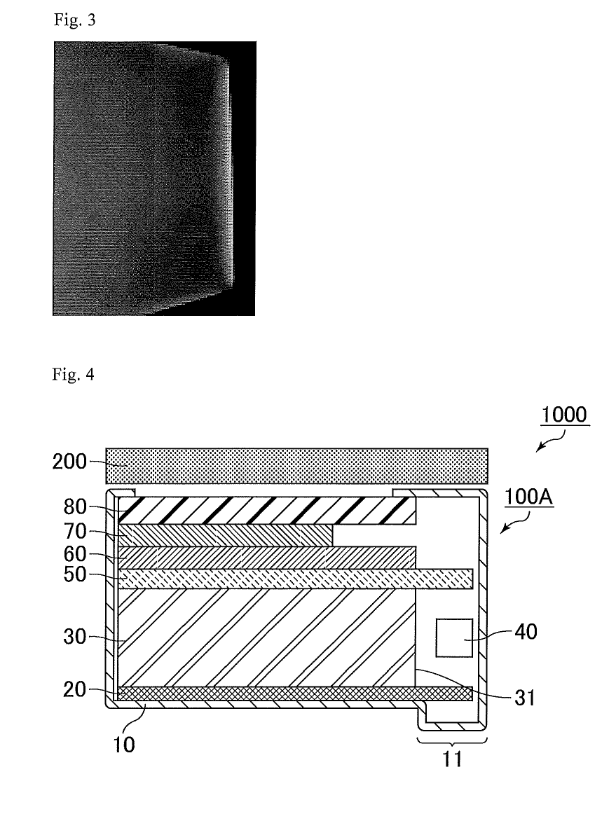

As shown in FIG. 2, the first optical sheet 70 has on its surface a structural member 71 extending, in a plan view, in a direction in which light is emitted by the light source 40 toward the light guide plate 30. The structural member 71 reflects and diffuses light emitted by the light guide plate 30 toward the front of the backlight device, thereby achieving the light-concentrating effect described above. However, in the case where the light emitted by the light source 40 is directly incident on the first optical sheet 70, luminance unevenness occurs along the structural member 71. Such direct incidence of light emitted by the light source 40 can be prevented by situating the first optical sheet 70 such that an edge thereof adjacent to the light source 40 is farther from the light source 40 than an edge of the light guide plate 30 adjacent to the light source 40 is in a plan view. Thereby, generation of streaky or other luminance unevenness can be reduced. FIG. 3 is a photograph showing a light diffusion state in Embodiment 1. As shown in FIG. 3, generation of streaky or other luminance unevenness was reduced in Embodiment 1.

In Embodiment 1, since the first optical sheet 70 is situated such that an edge thereof adjacent to the light source 40 is farther from the light source 40 than an edge of the light guide plate 30 adjacent to the light source 40 is in a plan view, the light emitted by the light source 40 is not directly incident on the first optical sheet 70, and thus generation of streaky or other luminance unevenness can be reduced. The first optical sheet 70 may also be situated such that an edge thereof adjacent to the light source is farther from the light source 40 than an edge of the diffusion sheet 50 adjacent to the light source and an edge of the polarizing sheet 80 adjacent to the light source are in a plan view. The light-emitting surface of the light source 40 and the edge surface 31 of the light guide plate 31 are spaced from each other by, for example, 0.5 to 1 mm. The light-emitting surface of the light source 40 and the edge of the first optical sheet 70 adjacent to the light source 40 are spaced from each other by, for example, 1.2 to 2 mm.

Examples of the structural member 71 include a linear recess, a linear protrusion, and a structure in which objects such as triangular pyramids, square pyramids, or hemispheres are arranged. In particular, a linear recess or a linear protrusion is preferred. In the case where the structural member 71 consists of a linear recess or a linear protrusion, direct incidence of light emitted by the light source 40 on the structural member 71 is more likely to cause streaky or other luminance unevenness along the linear recess or the linear protrusion. Hence, particularly in the case where the structural member 71 consists of a linear recess or a linear protrusion, generation of luminance unevenness can be more effectively reduced by situating the first optical sheet 70 such that an edge thereof adjacent to the light source 40 is farther from the light source 40 than an edge of the light guide plate 30 adjacent to the light source 40 is in a plan view.

The light guide plate 30 emits light incident from the edge surface 31 toward the front. The light guide plate 30 can be one commonly used in the field of backlight devices. The material of the light guide plate 30 can be any material that transmits light, such as a transparent resin. Examples of the transparent resin include acrylic resin and polycarbonate (PC) resin.

The light source 40 is disposed to face the edge surface 31 of the light guide plate 30 along the edge surface 31. The light source 40 may be a linear light source or a point light source. The point light source is preferably a group of point light sources disposed to face the edge surface 31. Examples of the linear light source include cold cathode fluorescent lamps (CCFLs). Examples of the point light source include light emitting diodes (LEDs). Light emitted by light emitting diodes has a straight-traveling characteristic, and is likely to cause streaky or other luminance unevenness. Hence, in a configuration in which the first optical sheet 70, having the structural member 71 extending in a direction of incoming light from the light emitting diodes, is situated such that an edge of the first optical sheet 70 is spaced from the light emitting diodes, the effect of reducing streaky or other luminance unevenness can be effectively achieved. In the case where the backlight device is used for a liquid crystal display device, the light emitting diodes are preferably white light emitting diodes.

Although generation of streaky or other luminance unevenness can be reduced by situating the first optical sheet 70 such that an edge thereof adjacent to the light source 40 is farther from the light source 40 than an edge of the light guide plate 30 adjacent to the light source 40 is in a plan view, the backlight device may further include the second optical sheet 60 for a higher light-concentrating effect.

In Embodiment 1, the second optical sheet 60 is disposed between the light guide plate 30 and the first optical sheet 70. In order to reduce generation of streaky or other luminance unevenness, in a cross-sectional view, the light source 40 is preferably situated such that the light-emitting surface thereof does not cross a straight line connecting a front corner of the light guide plate 30 adjacent to the light source 40 and a back corner of the first optical sheet 70 adjacent to the light source 40. Meanwhile, if an edge of the first optical sheet 70 adjacent to the light source 40 is too far from the light source 40, the edge of the sheet may be detectable through the light-emitting surface of the backlight device. For these reasons, in order to reduce generation of luminance unevenness, the first optical sheet 70 is preferably situated such that an edge thereof adjacent to the light source 40 is properly spaced from the light source 40, and the first optical sheet 70 is preferably disposed in a front part of the backlight device.

For adjustment of the light-concentrating direction and the viewing angle in actual use, the second optical sheet 60 may be disposed on the front surface of the first optical sheet 70.

The second optical sheet 60 may be a lens sheet. The second optical sheet 60 may also include a linear recess or a linear protrusion that extends in a direction perpendicular to the structural member formed on the surface of the first optical sheet 70. The second optical sheet 60 can effectively enhance the light-concentrating function in combination with the first optical sheet 70, especially in the case where the structural member formed on the surface of the first optical sheet 70 is a linear recess or linear protrusion. Also, since the extending direction of the linear recess or linear protrusion of the second optical sheet 60 is perpendicular to the direction in which light is emitted by the light source 40 toward the light guide plate 30, direct incidence of light emitted by the light source 40 on the second optical sheet 60 is not likely to cause luminance unevenness. The second optical sheet 60, unlike the first optical sheet 70, may therefore be situated such that an edge thereof adjacent to the light source 40 is closer to the light source 40 than an edge of the first optical sheet 70 adjacent to the light source 40 is in a plan view.

Embodiment 1 employs the diffusion sheet 50 disposed on the front surface of the light guide plate 30. The diffusion sheet can be one commonly used in the field of backlight devices. The diffusion sheet can further diffuse light emitted by the light source 40 and diffused by the light guide plate 30, thereby reducing generation of luminance unevenness. The diffusion sheet can be obtained by, for example, mixing materials with different refractive indexes, dispersing clear spherical particles on a clear sheet, or forming protrusions and recesses on a surface of a clear sheet.

Embodiment 1 employs the polarizing sheet 80 in front of the first optical sheet 70. The polarizing sheet 80 is an optical sheet that transmits only incident light polarized linearly in a given direction. The polarizing sheet can be one commonly used in the field of backlight devices. The material of the polarizing sheet 80 may be any material such as polycarbonate (PC) resin and polyethylene terephthalate (PET) resin.

Embodiment 1 employs, behind the light guide plate 30, the frame 10 and the reflective sheet 20 disposed in the given order from back to front of the backlight device. The frame 10 is a member constituting the outer frame of the backlight device and is disposed at least behind the backlight device. The frame 10 may be further disposed beside the backlight device. The material of the frame 10 may be any material such as aluminum.

The frame 10 may include, behind the backlight device, a recess 11 that faces the light source 40. In the recess 11 may be placed conductive lines of a flexible printed circuit (FPC) on which light sources are mounted, for example.

The reflective sheet 20 can be one commonly used in the field of backlight devices. The reflective sheet 20 may be any reflective sheet that reflects light emitted by the light source 40 and light incident on the back surface thereof from the light guide plate 30. Examples of the reflective sheet include thin films of a metal such as silver or aluminum. The reflective sheet 20, reflecting light emitted by the light source 40 and light incident on the back surface thereof from the light guide plate 30 toward the light guide plate 30, can therefore increase the amount of light emitted from the light-emitting surface of the backlight device.

The edge-lit backlight device 100A of Embodiment 1 is disposed behind a liquid crystal panel in a liquid crystal display device. FIG. 4 is a schematic cross-sectional view of an exemplary liquid crystal display device 1000 including the edge-lit backlight device 100A of Embodiment 1. As shown in FIG. 4, the edge-lit backlight device 100A may be disposed behind a liquid crystal panel 200. The liquid crystal panel 200 can be one commonly used in the field of liquid crystal display devices. The liquid crystal panel 200 may have a configuration in which, for example, a color filter substrate including members such as color filters and a counter electrode, a liquid crystal layer, and a TFT substrate including members such as pixel electrodes, signal lines, and thin-film transistors are stacked in the given order, and paired polarizing plates are disposed on the surfaces of the respective color filter substrate and TFT substrate opposite to the liquid crystal layer.

### Comparative Embodiment 1

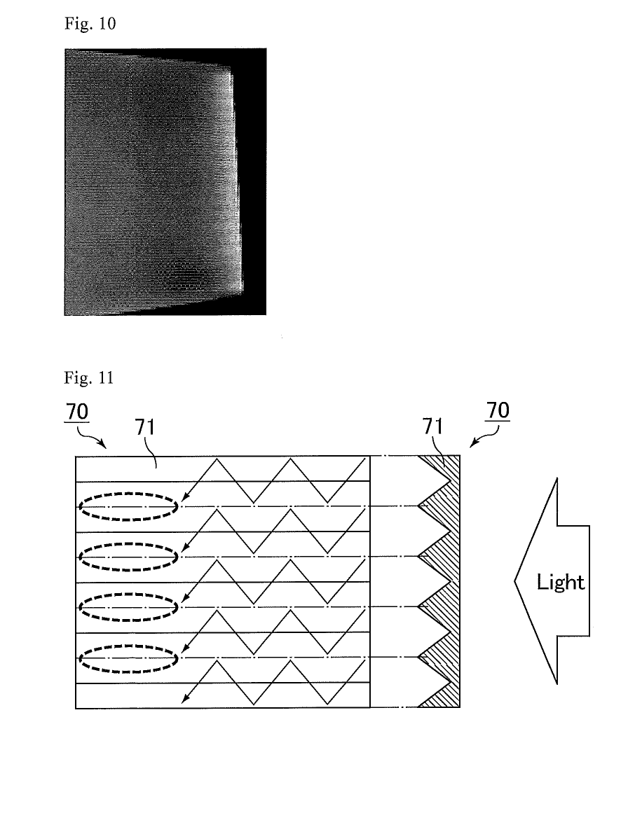

Comparative Embodiment 1 is similar to Embodiment 1, except that the edge of the first optical sheet adjacent to the light source and the edge surface of the light guide plate are aligned with each other. FIG. 10 is a photograph showing a light diffusion state in Comparative Embodiment 1. As shown in FIG. 10, streaky luminance unevenness was significantly noticeable in Comparative Embodiment 1. The first optical sheet 70 includes the structural member 71 extending in a direction in which light is emitted by the light source 40 toward the light guide plate 30. In

Comparative Embodiment 1, since the edge of the first optical sheet 70 adjacent to the light source 40 and the edge surface 31 of the light guide plate 30 are aligned with each other, the light emitted by the light source 40 is directly incident on the first optical sheet 70. The light directly incident on the first optical sheet 70 is reflected along the structural member 71, so that streaky luminance unevenness was observed as shown in FIG. 10.

Comparison between FIG. 3 and FIG. 10 shows that generation of streaky luminance unevenness can be effectively reduced by changing, in a plan view, the position of the edge of an optical sheet having on its surface a structural member extending in a direction in which light is emitted by the light source toward the light guide plate.

### Embodiment 2

Embodiment 2 is similar to Embodiment 1, except that the position of the edge of the reflective sheet adjacent to the light source is different, and the surface of the frame facing the light guide plate has a higher reflectance than the surface of the reflective sheet facing the light guide plate.

In the case where the light source of the edge-lit backlight device is a group of aligned point light sources such as LEDs, luminance unevenness is sometimes observed between a part with the light source and a part without the light source. The studies made by the inventor revealed that in the case where the light source 40 is a group of point light sources such as LEDs, the light therefrom has a straight-traveling characteristic and thus almost always passes through the light guide plate 30 without a change in the critical angle near the edge surface 31 of the light guide plate 30 adjacent to the light source 40. For this reason, observation of the backlight device from an oblique direction shows more significant contrast of light strength between the part with the light source 40 and the part without the light source 40. One possible way to deal with the luminance unevenness of light from the light source 40 is to mold the edge surface 31 of the light guide plate 30 adjacent to the light source 40 into a shape such as a V-cut shape, for example, for diffusion of the incident light. However, in this way, the distance between the point light sources of the light source 40 is too wide compared to the distance between the light source 40 and the edge surface 31 of the light guide plate 30, and thus the incident light was insufficiently diffused to fail to reduce luminance unevenness. The inventor has then arrived at a configuration in which the surface of the frame 10 facing the light guide plate 30 has a higher reflectance than the surface of the reflective sheet 20 facing the light guide plate 30 and the reflective sheet 20 is situated such that an edge thereof adjacent to the light source 40 is farther from the light source 40 than the edge surface 31 of the light guide plate 30 is in a plan view. This configuration has been found to enable utilization of specular reflection by the frame 10 to superficially widen the range of light from the light source 40 in observation from an oblique direction, widening the light-emitting region. The inventor has therefore found that the luminance unevenness between the part with the light source and the part without the light source can be reduced even in observation of the backlight device from an oblique direction.

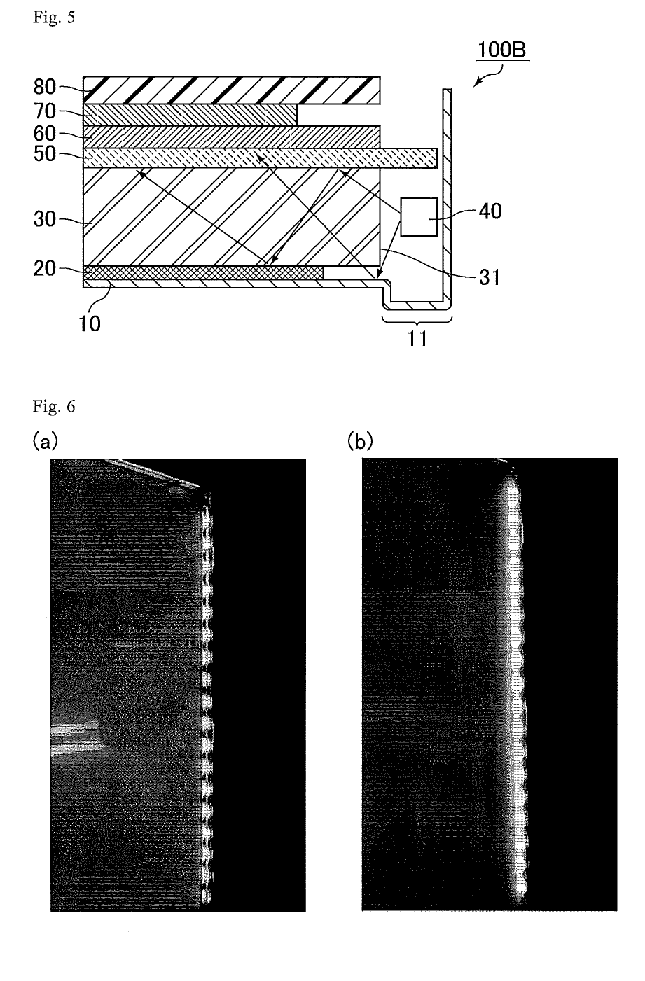

FIG. 5 is a schematic cross-sectional view of an exemplary edge-lit backlight device of Embodiment 2. As shown in FIG. 5, in Embodiment 2, the reflective sheet 20 is situated such that an edge thereof adjacent to the light source 40 is farther from the light source 40 than the edge surface 31 of the light guide plate 30 is in a plan view. The surface of the frame 10 facing the light guide plate 30 has a higher reflectance than the surface of the reflective sheet facing the light guide plate 30. The material of the frame 10 may be any material giving a total reflectance of 50% or higher to the surface of the frame 10 facing the light guide plate 30, such as aluminum or SECC (an electrolytic zinc-coated steel sheet). The light source 40 here is a group of point light sources.

FIG. 6 shows photographs showing light diffusion states, with the position of an edge of a reflective sheet changed. FIG. 6(a) is a photograph taken when light is emitted by the light source 40 to the frame 10 and the reflective sheet 20, while FIG. 6(b) is a photograph taken when light is emitted by the light source 40 to the frame 10, the reflective sheet 20, the light guide plate 30, and the diffusion sheet 50. Comparison between FIG. 6(a) and FIG. 6(b) shows that the light emitted by the light source 40 is reflected and diffused by the light guide plate 30 and the diffusion sheet 50, with no luminance unevenness observed between point light sources.

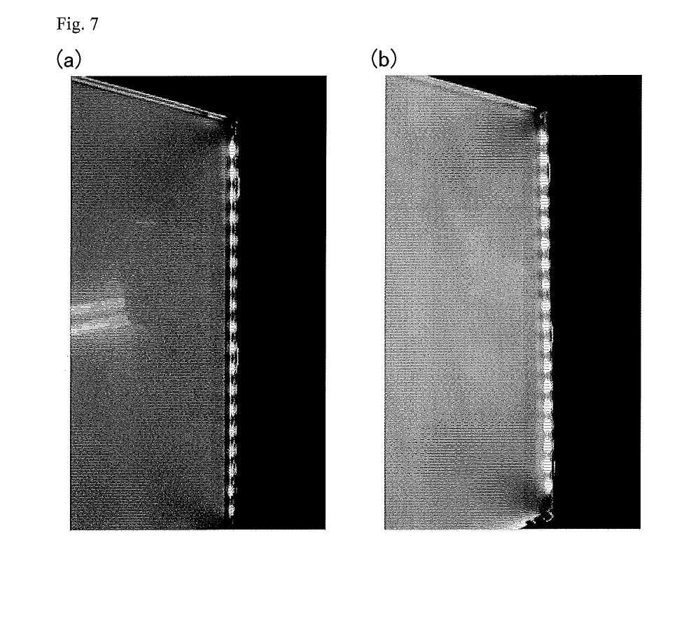

For reference, the following shows light diffusion states in the case where the position of the edge of the reflective sheet is not changed, i.e., in the case where the edge of the reflective sheet 20 adjacent to the light source 40 is aligned with the edge of the light guide plate 30 adjacent to the light source 40. FIG. 7 shows photographs showing light diffusion states, with the position of an edge of a reflective sheet unchanged. FIG. 7(a) is a photograph taken when light is emitted by the light source 40 to the frame 10 and the reflective sheet 20, while FIG. 7(b) is a photograph taken when light is emitted by the light source 40 to the frame 10, the reflective sheet 20, the light guide plate 30, and the diffusion sheet 50. Comparison between FIG. 7(a) and FIG. 7(b) shows that the light emitted by the point light sources of the light source 40 is insufficiently mixed light; the light was observed to be reflected and diffused by the light guide plate 30 and the diffusion sheet 50, but involved luminance unevenness between the point light sources.

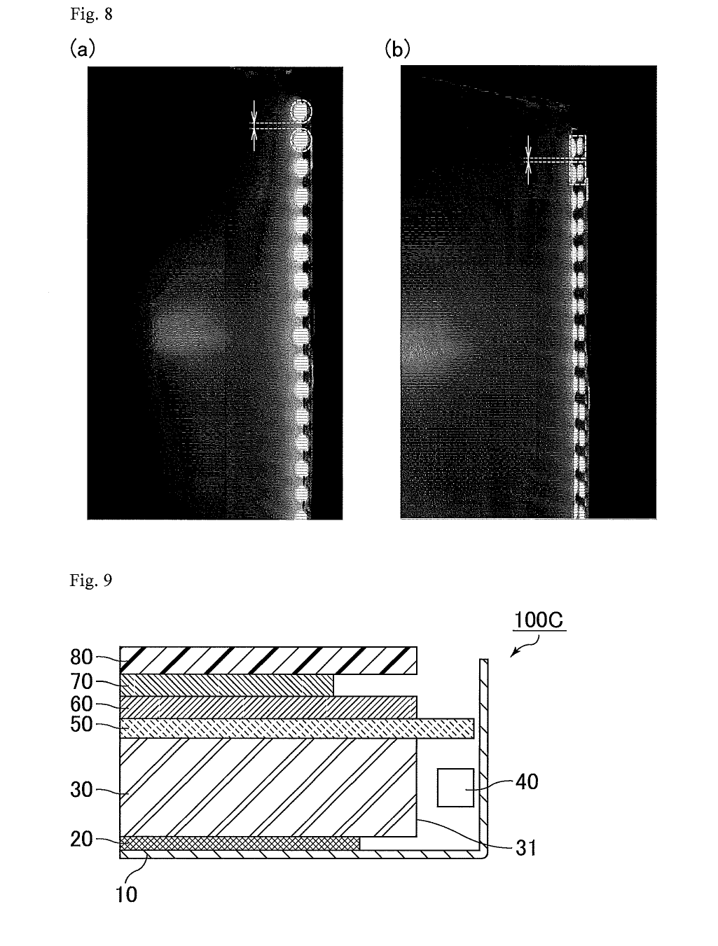

In addition, the part with the light source 40 and the part without the light source 40 were compared. FIG. 8 shows photographs comparing reflection states with an edge of a reflective sheet situated at different positions. FIG. 8(a) and FIG. 8(b) are both photographs taken when light is emitted by the light source 40 to the frame 10 and the reflective sheet 20. FIG. 8(a) is a photograph taken when the edge of the reflective sheet 20 adjacent to the light source 40 is aligned with the edge of the light guide plate 30 adjacent to the light source 40, while FIG. 8(b) is a photograph taken when the edge of the reflective sheet 20 adjacent to the light source 40 is farther from the light source 40 than the edge of the light guide plate 30 adjacent to the light source 40 is. Comparison between FIG. 8(a) and FIG. 8(b) shows that the distance between point light sources in FIG. 8(b) is narrower and the range of light from one point light source is wider than in FIG. 8(a).

In Embodiment 2, the range of light from the light source 40 is superficially widened by allowing light emitted by the light source 40 as well as light emitted by the light source 40 and then reflected by the frame 10 to be incident on the light guide plate 30. Thereby, the backlight device of Embodiment 2 can reduce streaky or other luminance unevenness caused by the structural member 71 of the first optical sheet 70 as well as luminance unevenness between the part with the light source 40 and the part without the light source 40 observed in observation of the backlight device from an oblique direction.

The front surface of the frame 10 may include protrusions and recesses. The protrusions and recesses may have any shape, but preferably have a shape with which the angle of light can be changed to complement the luminance of the part without the light source 40, such as hemispheres, cones, triangular pyramids, or square pyramids. The protrusions and recesses can further diffuse the light reflected by the frame 10.

### Modified Embodiment 1

In Modified Embodiment 1, the light source 40 is a group of point light sources, the surface of the frame 10 facing the light guide plate 30 has a higher reflectance than the surface of the reflective sheet facing the light guide plate 30, and the edge of the reflective sheet 20 adjacent to the light source 40 is farther from the light source 40 than the edge surface 31 of the light guide plate 30 is in a plan view. Modified Embodiment 1 utilizes specular reflection by the frame 10 to superficially widen the range of light from the light source 40 in observation from an oblique direction. In addition, the range of light from the light source 40 is superficially widened by allowing light emitted by the light source 40 as well as light emitted by the light source 40 and then reflected by the frame 10 to be incident on the light guide plate 30. Modified Embodiment 1 may not necessarily employ the first optical sheet 70 from the viewpoint of achieving the effect of superficially widening the range of light from the light source 40. Yet, Modified Embodiment 1 may employ the first optical sheet 70 and the first optical sheet 70 may be situated such that an edge thereof adjacent to the light source 40 is farther from the light source 40 than the edge surface 31 of the light guide plate 30 is in a plan view.

### Embodiment 3

Embodiment 3 is similar to Embodiment 2 except that the frame 10 does not include a recess facing the light source 40 behind the backlight device. FIG. 9 is a schematic cross-sectional view showing an exemplary edge-lit backlight device of Embodiment 3. As shown in FIG. 9, the frame 10 has an L shape without a recess below the light source 40. As with Embodiment 2, Embodiment 3 can also reduce streaky or other luminance unevenness caused by the structural member 71 of the first optical sheet 70 as well as luminance unevenness between the part with the light source 40 and the part without the light source 40.

### Additional Remarks

One aspect of the present invention may be an edge-lit backlight device including: a light guide plate configured to emit light incident from an edge surface thereof toward the front; a light source disposed to face the edge surface of the light guide plate with a space in between; and a first optical sheet disposed in front of the light guide plate, the first optical sheet including a structural member extending, in a plan view, in a direction in which light is emitted by the light source toward the light guide plate, the first optical sheet being situated such that an edge thereof adjacent to the light source is farther from the light source than the edge surface of the light guide plate is in a plan view. Since the first optical sheet is situated such that an edge thereof adjacent to the light source is farther from the light source than the edge surface of the light guide plate is in a plan view, the light emitted by the light source is not directly incident on the optical sheet having on its surface a structural member extending in a direction in which light is emitted by the light source toward the light guide plate, and thus generation of streaky or other luminance unevenness can be reduced.

The first optical sheet may be a lens sheet.

The structural member may consist of a linear recess or a linear protrusion.

The edge-lit backlight device may further include a second optical sheet including a linear recess or a linear protrusion that extends in a direction perpendicular to the structural member of the first optical sheet, wherein the second optical sheet is situated such that an edge thereof adjacent to the light source is closer to the light source than the edge of the first optical sheet adjacent to the light source is in a plan view. The second optical sheet can further enhance the light-concentrating effect.

The second optical sheet may be disposed between the light guide plate and the first optical sheet. With the second optical sheet disposed between the light guide plate and the first optical sheet, the first optical sheet can be made closer to the front of the backlight device, so that generation of luminance unevenness can be reduced while the light-concentrating effect is maintained.

The second optical sheet may be a lens sheet.

The edge-lit backlight device may further include a diffusion sheet on the front surface of the light guide plate, wherein the first optical sheet is situated such that an edge thereof adjacent to the light source is farther from the light source than an edge of the diffusion sheet adjacent to the light source is in a plan view. The diffusion sheet can further diffuse light emitted by the light source and diffused by the light guide plate, reducing generation of luminance unevenness.

The edge-lit backlight device may further include a polarizing sheet in front of the first optical sheet, wherein the first optical sheet is situated such that an edge thereof adjacent to the light source is farther from the light source than an edge of the polarizing sheet adjacent to the light source is in a plan view. The polarizing sheet transmits only light that is emitted by the light guide plate and linearly polarized in a given direction. Such a backlight device is suitable for use as a backlight device of a liquid crystal display device.

The edge-lit backlight device may further include, behind the light guide plate, a frame and a reflective sheet in the given order from back to front, wherein the light source is a point light source, a surface of the frame facing the light guide plate has a higher reflectance than a surface of the reflective sheet facing the light guide plate, and the reflective sheet is situated such that an edge thereof adjacent to the point light source is farther from the point light source than the edge surface of the light guide plate is in a plan view. Light emitted by a point light source has a straight-traveling characteristic, and is likely to cause luminance unevenness between the part with the light source and the part without the light source in observation from an oblique direction. Generation of such luminance unevenness can be reduced by a configuration in which the surface of the frame facing the light guide plate has a higher reflectance than the surface of the reflective sheet facing the light guide plate and the reflective sheet is situated such that an edge thereof adjacent to the light source is farther from the light source than the edge surface of the light guide plate is in a plan view. This is because the above configuration enables utilization of specular reflection by the frame to superficially widen the range of light from the light source in observation from an oblique direction.

The surface of the frame facing the light guide plate may include protrusions and recesses. The protrusions and recesses enable further diffusion of light reflected by the frame.

The light source may be a light emitting diode. Light emitted by a light emitting diode has a straight-traveling characteristic, and is likely to cause streaky or other luminance unevenness. Hence, in a configuration in which the first optical sheet, having the structural member extending in a direction of incoming light from the light emitting diodes, is situated such that an edge of the first optical sheet is spaced from the light emitting diode, the effect of reducing streaky or other luminance unevenness can be effectively achieved.

Another aspect of the present invention may be an edge-lit backlight device including: a light guide plate configured to emit light incident from an edge surface thereof toward the front; a light source disposed to face the edge surface of the light guide plate with a space in between; and behind the light guide plate, a frame and a reflective sheet in the given order from back to front, the light source being a point light source, the surface of the frame facing the light guide plate having a higher reflectance than the surface of the reflective sheet facing the light guide plate, the reflective sheet being situated such that an edge thereof adjacent to the point light source being farther from the point light source than the edge surface of the light guide plate is in a plan view. With the specular reflection by the frame, the range of light from the light source in observation from an oblique direction can be superficially widened. Also, the range of light from the light source is superficially widened by allowing light emitted by the light source as well as light emitted by the light source and then reflected by the frame to be incident on the light guide plate.

Yet another aspect of the present invention may be a liquid crystal display device including: a liquid crystal panel; and the above edge-lit backlight device, the edge-lit backlight device being disposed behind the liquid crystal panel.

### REFERENCE SIGNS LIST

10: Frame
11: Recess in frame
20: Reflective sheet
30: Light guide plate
31: Edge surface of light guide plate
40: Light source
50: Diffusion sheet
60: Second optical sheet
70: First optical sheet
71: Structural member
80: Polarizing sheet
100A: Edge-lit backlight device of Embodiment 1
100B: Edge-lit backlight device of Embodiment 2
100C: Edge-lit backlight device of Embodiment 3
200: Liquid crystal panel
1000: Liquid crystal display device including edge-lit backlight device of Embodiment 1

1. An edge-lit backlight device comprising:
a light guide plate configured to emit light incident from an edge surface thereof toward the front;
a light source disposed to face the edge surface of the light guide plate with a space in between; and
a first optical sheet disposed in front of the light guide plate,
the first optical sheet including a structural member extending, in a plan view, in a direction in which light is emitted by the light source toward the light guide plate,
the first optical sheet being situated such that an edge thereof adjacent to the light source is farther from the light source than the edge surface of the light guide plate is in a plan view.

2. The edge-lit backlight device according to claim 1,
wherein the first optical sheet is a lens sheet.

3. The edge-lit backlight device according to claim 1,
wherein the structural member consists of a linear recess or a linear protrusion.

4. The edge-lit backlight device according to claim 1, further comprising a second optical sheet including a linear recess or a linear protrusion that extends in a direction perpendicular to the structural member of the first optical sheet,
wherein the second optical sheet is situated such that an edge thereof adjacent to the light source is closer to the light source than the edge of the first optical sheet adjacent to the light source is in a plan view.

5. The edge-lit backlight device according to claim 4,
wherein the second optical sheet is disposed between the light guide plate and the first optical sheet.

6. The edge-lit backlight device according to claim 4,
wherein the second optical sheet is a lens sheet.

7. The edge-lit backlight device according to claim 1, further comprising a diffusion sheet on the front surface of the light guide plate,
wherein the first optical sheet is situated such that an edge thereof adjacent to the light source is farther from the light source than an edge of the diffusion sheet adjacent to the light source is in a plan view.

8. The edge-lit backlight device according to claim 1, further comprising a polarizing sheet in front of the first optical sheet,
wherein the first optical sheet is situated such that an edge thereof adjacent to the light source is farther from the light source than an edge of the polarizing sheet adjacent to the light source is in a plan view.

9. The edge-lit backlight device according to claim 1, further comprising, behind the light guide plate, a frame and a reflective sheet in the given order from back to front,
wherein the light source is a point light source,
a surface of the frame facing the light guide plate has a higher reflectance than a surface of the reflective sheet facing the light guide plate, and
the reflective sheet is situated such that an edge thereof adjacent to the point light source is farther from the point light source than the edge surface of the light guide plate is in a plan view.

10. The edge-lit backlight device according to claim 9,
wherein the surface of the frame facing the light guide plate includes protrusions and recesses,

11. The edge-lit backlight device according to claim 1,
wherein the light source is a light emitting diode.

12. A liquid crystal display device comprising:
a liquid crystal panel; and
the edge-lit backlight device according to claim 1, the edge-lit backlight device being disposed behind the liquid crystal panel.
